(19) United States
(12) Patent Application Publication
(10) Pub. No.: US 2009/0223616 A1
(43) Pub. Date: Sep. 10, 2009

(54) PNEUMATIC TIRE

(75) Inventor: Hiroshi TAKADA, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA BRIDGESTONE, Tokyo (JP)

(21) Appl. No.: 12/396,903

(22) Filed: Mar. 3, 2009

(30) Foreign Application Priority Data
Mar. 4, 2008 (JP) 2008-052758

(51) Int. Cl. B60C 3/04

(52) U.S. Cl. 152/454

(57) ABSTRACT

A pneumatic tire has a tread with a side surface on each axially outermost side thereof. The side surface is formed by a shoulder land portion at tread edge rising from a sidewall. The angle between a tangent to the side surface from the bottom thereof and a tangent to the surface of the sidewall 12 connecting to the side surface from the bottom is 130 degrees or more and less than 180 degrees. Also, the angle between the tangent to the side surface and the radial direction of the tire is 20 degrees or more and degrees or less. This design not only ensures retention of the stiffness of the tread but also prevents ground contact of any part of tire surface other than the tread during heavy-load running or high-speed cornering of the vehicle.

### BACKGROUND OF THE INVENTION

1. Field of the Invention

The present invention relates to a pneumatic tire. In particular, the invention relates to an improvement of durability and steering performance of a pneumatic tire having a shape of land portion at tread edge rising from the sidewall.

2. Description of the Related Art

A conventional technique proposed to achieve a high-speed durability of high-performance pneumatic radial tires employs a shape of tire with a substantially reduced gauge in the region where, as shown in FIG. 4, a tread 51 of a tire 50 connects to a sidewall 52. The shape of tire with the substantially reduced gauge is, in other words, a shape in which the land portion at tread edge, as viewed in a meridional cross section of the tire, rises substantially vertically from the sidewall 52. The shape, which allows reduction of rubber volume in the vicinity of the vertex where the tread 51 meets the sidewall 52, lessens the heating of the rubber. Hence, the heat resistance of the tire 50 improves, which in turn ensures the high-speed durability thereof.

Examples of the technique as described above can be found in Japanese Unexamined Patent Application Publication No. 59-213502 and Japanese Unexamined Patent Application Publication No. 7-25206.

However, tires having the above-described shape of the land portion 53 at tread edge rising vertically from the sidewall 52 have a relatively small angle θ between the side surface 53S of the axially outermost land portion 53 and the surface 52S of the sidewall 52 connecting to the side surface 53S. This is disadvantageous in that during heavy-load or high-speed running of the vehicle, surfaces of the tire other than the tread 51 can make contact with the road surface, which will adversely affect the steering performance of the tire.

It is also known that the larger the camber angle (CA) is, the more marked the above-mentioned negative tendency will be. Also, the sidewall 52, which has a thin rubber layer, can wear off through contact with the road surface, and consequently the durability of the tire may drop.

### SUMMARY OF THE INVENTION

The present invention has been made to solve these known problems, and an object thereof is to improve both the steering performance and durability of a pneumatic tire having a shape of land portion at tread edge rising from the sidewall.

In a first aspect of the invention, a pneumatic tire comprises a tread having a side surface on each axially outermost side thereof, the side surface being formed by a land portion at tread edge rising from a sidewall, wherein an angle between the side surface and a surface of the sidewall connecting to the side surface is 130 degrees or more and less than 180 degrees.

In a second aspect of the invention, the pneumatic tire has an angle between the direction of a tangent drawn to the side surface from the bottom thereof and the radial direction of the tire being 20 degrees or more and 40 degrees or less.

In a third aspect of the invention, the pneumatic tire is used at low internal air pressures of 200 kPa or below.

Accordingly, the present invention, which sets the angle between the side surface on each axially outermost side of the tread and the surface of the sidewall connecting to the side surface to be 130 degrees or more and less than 180 degrees, allows the tread only to make contact with the road surface, without the sidewall portion with a thin rubber layer touching the ground, even during heavy-load or high-speed running of the vehicle. This will improve both the durability and steering performance of the pneumatic tire.

Also, the present invention, which sets the angle between the direction of a tangent drawn to the side surface from the bottom thereof and the radial direction of the tire to be 20 degrees or more and 40 degrees or less, ensures retention of the stiffness of the tread 11 during heavy-load running of the vehicle and thus prevents any part of tire surface other than the tread from touching the ground.

Further, the present invention can be applied to pneumatic tires that are used with low internal air pressures of 200 kPa or below, thus being subject to larger deformation of the tread during heavy-load running of the vehicle, with more of the advantageous effects of the invention.

### BRIEF DESCRIPTION OF THE DRAWINGS

Preferred embodiments of the present invention will now be described, by way of example only, with reference to the drawings, in which

FIG. 1 illustrates a structure of a pneumatic tire according to the best mode for carrying out the invention.

FIG. 2 illustrates a state of ground contact of the tire according to the present invention.

FIG. 3 illustrates a state of ground contact of the conventional tire which has a smaller angle θ.

FIG. 4 illustrates a structure of a conventional pneumatic tire.

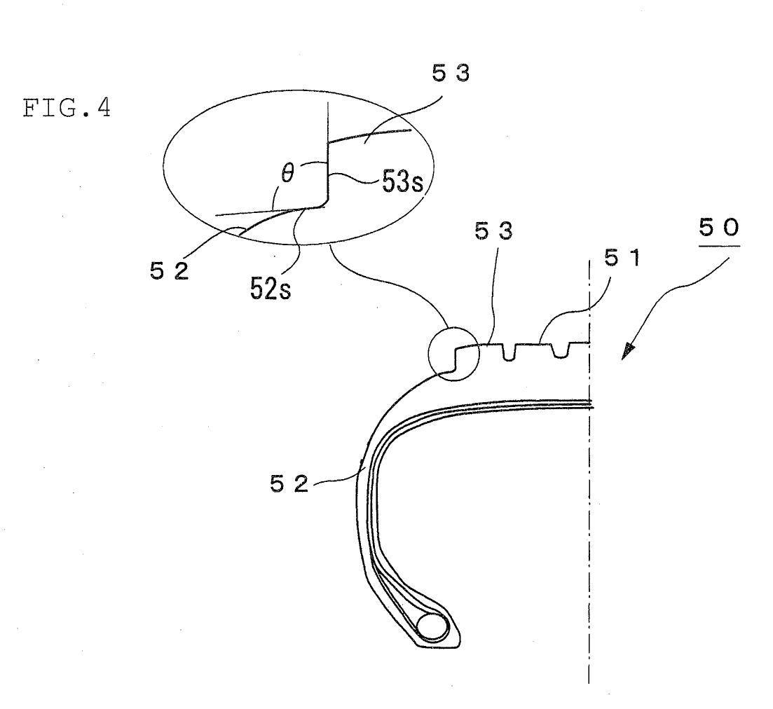

FIG. 5 illustrates tables showing data regarding examples.

### DETAILED DESCRIPTION OF THE INVENTION

The invention will now be described based on preferred embodiments which do not intend to limit the scope of the present invention but exemplify the invention. Herein below, the preferred embodiments are explained referring to the drawings.

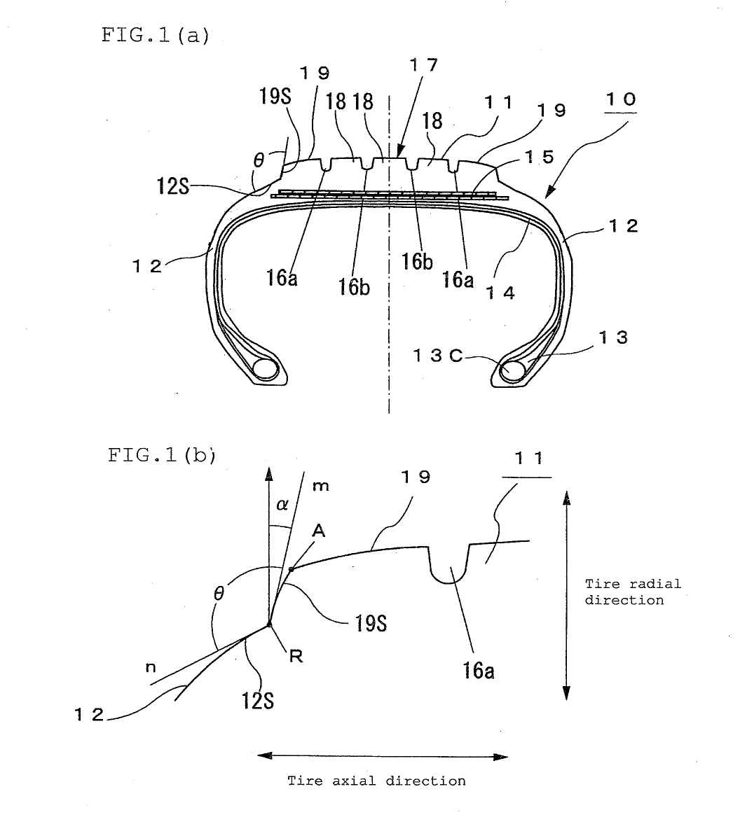

FIGS. 1A and 1B illustrate a structure of a pneumatic tire (hereinafter referred to as “tire”) 10 according to a preferred embodiment of the invention. FIG. 1A is a meridian cross section of the tire, whereas FIG. 1B is an enlarged view of a feature thereof. The tire 10 includes a tread 11, sidewalls 12, beads 13, a body ply 14 toroidally straddling a pair of bead cores 13C disposed in the beads 13, a belt layer 15 comprising a plurality of belt plies disposed on a radially outer side of the body ply 14. The tread 11, made of a rubber member (tread rubber), is disposed on a radially outer side of the belt layer 15.

Also, side circumferential grooves 16a, 16a, which are located in axially outer positions of the tread 11, extend along the circumference of the tire. Intermediate circumferential grooves 16b, 16b, which are located in the tread 11 closer to the tread center 17 than the side circumferential grooves 16a, 16a, extend along the circumference of the tire also.

Intermediate land portions 18 are defined by a side circumferential groove 16a and an intermediate circumferential groove 16b or by intermediate circumferential grooves 16b, 16b, whereas axially outer side land portions 19 are land portions located on axially outer sides of the side circumferential grooves 16a, 16a.

The axially outer side land portion 19 located at a tread edge A is so formed as to rise from the sidewall 12 and has a side surface 19S on an axially outermost side of the tread.

In the embodiments of the present invention, the angle α between the direction of a tangent m drawn to the side surface 19S from the bottom R thereof and the radial direction of the tire is 20° or more and 40° or less as viewed in a meridional cross section of the tire. At the same time, the angle θ between the side surface 19S and the surface of the sidewall 12 connecting to the side surface 19S (hereinafter referred to as “connecting surface”), which is the angle between the tangent m drawn to the side surface 19S from the bottom R thereof and a tangent n drawn to the connecting surface 12S from the bottom R, is 130° or more and less than 180°.

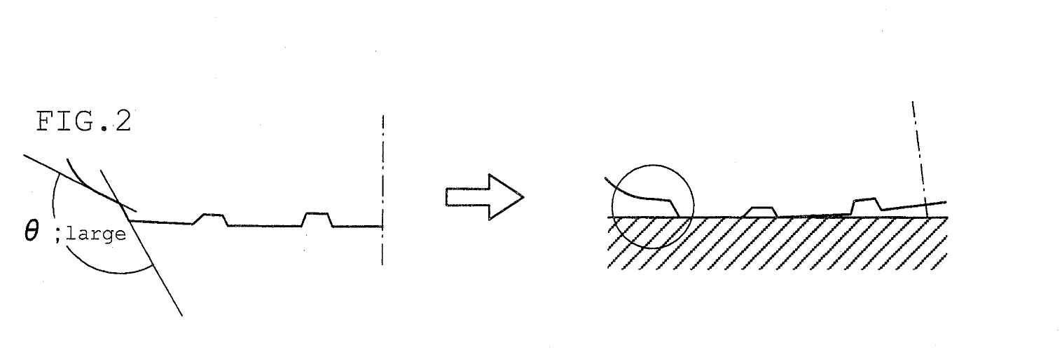

FIG. 2 illustrates the above-described arrangement by which the risk of tire surface other than the tread making contact with the road surface during heavy-load running is eliminated. This arrangement can also increase the stiffness of the tread in contrast to the conventional design which has the land portion at tread edge rising vertically from the sidewall.

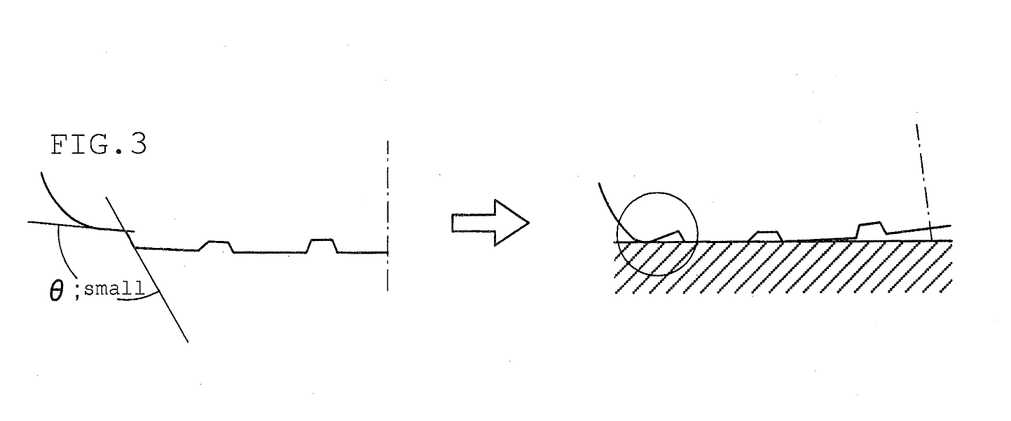

FIG. 3 illustrates a case where the angle θ is less than 130°. In this case, a part of tire surface other than the tread makes contact with the road surface in heavy-load operation, which results in a drop in both the steering performance and durability of the tire.

Also, even when the angle θ is 130° or more and less than 180°, the steering performance may be adversely affected if the angle α is less than 20°. In such a case, although part of tire surface other than the tread may not make contact with the road surface, there will be a drop in the stiffness of the tread in heavy-load running or high-speed cornering of the vehicle. Also, if the angle α is less than 20 degrees, the ground contact pressure at the tread edge will rise, thus setting off local wear of the affected region. Eventually, the tear of the tread edge may occur, further hastening the wear of the region.

On the other hand, if the angle α exceeds 40 degrees, there will be possibilities of part of tire surface other than the tread coming in contact with the ground even when the angle θ is close to 180 degrees.

Thus, the best mode for carrying out the invention relates to a pneumatic tire 10 comprising a tread having a side surface 19S on each axially outermost side thereof, the side surface being formed by a axially outer side land portion 19 at tread edge A rising from a sidewall 12. And the angle θ between a tangent m drawn to the side surface 19S from the bottom R thereof and a tangent n drawn to the connecting surface 12S of the sidewall 12 from the bottom R is 130 degrees or more and less than 180 degrees. At the same time, the angle α between the tangent m and the radial direction of the tire is 20° or more and 40° or less. Therefore, this embodiment can not only ensure retention of the stiffness of the tread 11 during heavy-load running of the vehicle but also prevent any part of tire surface other than the tread 11 from touching the ground. Accordingly, both the steering performance and durability of the pneumatic tire will be improved.

Moreover, the present invention can be applied to pneumatic tires that are used with low internal air pressures of 200 kPa or below, thus being subject to larger deformation of the tread 11 during heavy-load running or high-speed cornering of the vehicle, with more of the advantageous effects the invention. ?

### EXAMPLES

Tires according to the present invention (Present Inventions 1 and 2) with the angle θ between the side surface of the land portion at tread edge and the sidewall being 137 degrees and 152 degrees respectively and a tire with the angle θ being 128 degrees (Comparative Example 1) were prepared. And an investigation was conducted on each of the tires to see whether any part (side portion) of tire surface other than the tread makes contact with the ground in a heavy-load running of the vehicle loaded at 5.5 kN. Table 1 shows the results of the investigation.

The size of all the test tires was 245/40R17, and the internal pressure of the tires was 180 kPa.

Ground contact tests were carried out using a flat belt type testing machine. The speed employed in the tests was 56 km/h. Also, the camber angle (CA) was fixed at 2.5 degrees, which was larger than the normal CA (approximately 1 degree). And the slip angle (SA) was changed in the range of −10 degrees to 0 to +10 degrees while checking for ground contact of any part of tire surface other than the tread.

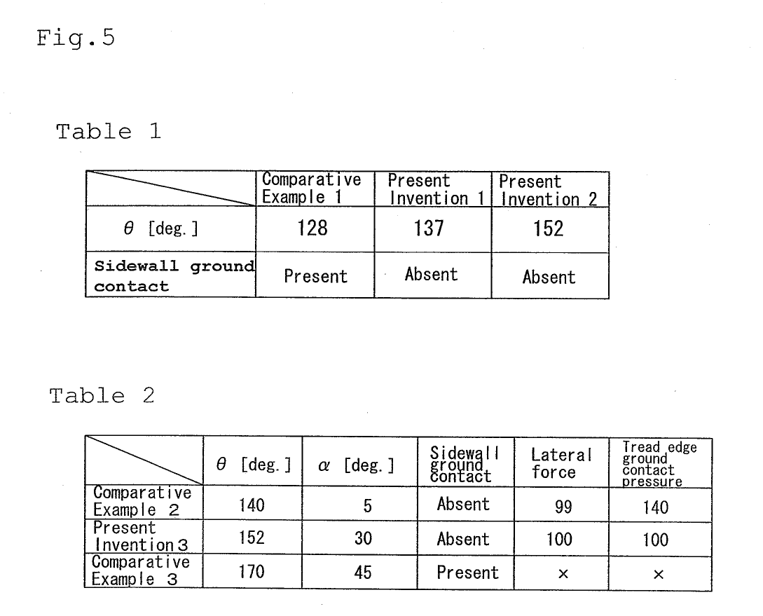

As is clear from Table 1 in the FIG. 5, with the tire of Comparative Example 1 whose angle θ between the tread and the sidewall was less than 130 degrees, a part of tire surface other than the tread came in contact with the ground during heavy-load running. On the other hand, it was confirmed that with the tires of Present Inventions 1 and 2 whose angle θ was more than 130 degrees, there was no ground contact of any part of tire surface other than the tread.

Also, tests were carried out on tires with the angle θ between the side surface of the land portion at tread edge and the sidewall being 130 degrees or more and less than 180 degrees. That is, a tire whose angle α between the tangent drawn to the side surface from the bottom thereof and the radial direction of the tire is 5 degrees (Comparative Example 2), a tire whose angle α is 30 degrees (Present Invention 3), and a tire whose angle α is 45 degrees (Comparative Example 3) were prepared. And an investigation was conducted on each of the tires to see whether any part (side portion) of tire surface other than the tread makes contact with the ground in a heavy-load running of the vehicle loaded at 5.5 kN. Also, measurements were made of the lateral forces working on the tires and the ground contact pressures at the tread edge. Table 2 shows the results of the tests. It is to be noted that in the table the lateral forces and the ground contact pressures at the tread edge are indicated by index numbers relative to the measured value of the tire of Present Invention 3 as 100.

The size of all the test tires was 245/40R17, and the internal pressure of the tires was 180 kPa.

Ground contact tests were carried out using a flat belt type testing machine. The speed employed in the test was 120 km/h. Also, the camber angle (CA) was set at 2.5 degrees, and the slip angle (SA) was set at 5 degrees.

As is evident from Table 2 in the FIG. 5, the tire of Comparative Example 2 whose angle α between the tangent drawn to the side surface of the land portion at tread edge from the bottom thereof and the radial direction of the tire is 5 degrees, showed no ground contact of any part of tire surface other than the tread, and the lateral force was equivalent to that of the tire of Present Invention 3. However, it showed a ground contact pressure being 40% higher than that of the tire of Present Invention 3.

The tire of Comparative Example 3 whose angle α was 45 degrees showed ground contact of a part of tire surface other than the tread despite its large angle θ between the side surface of the land portion at tread edge and the sidewall portion. Note that no measurements of the lateral force and the ground contact pressure at the tread edge were made with the tire of Comparative Example 3 which showed ground contact of a part of tire surface other than the tread.

Thus, the present invention not only ensures retention of the stiffness of the tread but also prevents ground contact of any part of tire surface other than the tread in heavy-load running or high-speed cornering of the vehicle. Hence, it can provide a pneumatic tire which excels in both the steering performance and durability thereof.

While the invention has been described in combination with embodiments thereof, it is evident that many alternatives, modifications, and variations will be apparent to those skilled in the art in light of the foregoing teachings. Accordingly, the invention is intended to embrace all such alternatives, modifications, and variations as fall within the spirit and scope of the appended claims.

The present application is based on Japanese Priority Application No. 2008-52758 filed on Mar. 4, 2008 with the Japanese Patent Office, the entire contents of which are hereby incorporated by reference.

What is claimed is:

1. A pneumatic tire comprising:
a tread having a side surface on each axially outermost side of the tread, the side surface being formed by a land portion at tread edge rising from a sidewall;
wherein an angle between the side surface and a surface of the sidewall connecting to the side surface is 130 degrees or more and less than 180 degrees.

2. A pneumatic tire of claim 1, wherein an angle between the direction of a tangent drawn to the side surface from the bottom thereof and the radial direction of the tire is 20 degrees or more and 40 degrees or less.

3. A pneumatic tire of claim 1 or claim 2, wherein the pneumatic tire is used at low internal air pressures of 200 kPa or below.
